(19) United States
(12) Patent Application Publication
(10) Pub. No.: US 2008/0037791 A1
(43) Pub. Date: Feb. 14, 2008

(54) Method and apparatus for evaluating actions performed on a client device

(76) Inventor: Bjorn Markus Jakobsson, Bloomington, IN (US)

Correspondence Address: LAW OFFICE OF JEFFREY M. WEINICK, LLC, 615 WEST MT. PLEASANT AVENUE, LIVINGSTON, NJ, 07039, US

(21) Appl. No.: 11/890,408

(22) Filed: Aug. 6, 2007

Related U.S. Application Data
(60) Provisional application No. 60/836,641, filed on Aug. 9, 2006.
(60) Provisional application No. 60/918,781, filed on Mar. 19, 2007.

(51) Int. Cl. H04L 9/08; G06F 21/00; H04L 9/30

(52) U.S. Cl. 380/278; 380/44; 726/24

(57) ABSTRACT

Disclosed is a method and apparatus for evaluating actions performed on a client device. For each of the performed actions, a current key is generated from a previous key and an associated action attestation value is generated from the previous key and information about each action (stored in a log file). The previous key is then deleted. A final attestation value is also generated using a publicly non-invertible function and is based at least on the current key. The client device transmits information about the performed actions (stored in a log file), the plurality of action attestation values, and the final attestation value to the server so that the server can authenticate the action attestation values and the final attestation value. If the server cannot authenticate these attestation values, then the server can determine that the log file has been tampered with.

This application claims the benefit of U.S. Provisional Application No. 60/836,641 titled “Method and Apparatus for Improved Web Security” filed on Aug. 9, 2006 and U.S. Provisional Application No. 60/918,781 titled “Secure Logging of Critical Events, Allowing External Monitoring” filed on Mar. 19, 2007, both of which are incorporated herein by reference.

### BACKGROUND OF THE INVENTION

The present invention relates generally to network communications, and more specifically to evaluating actions performed on a client device.

Audit logs have long been used to keep permanent records of critical events or actions. The audit log can be used at some future date to reconstruct events or actions that have occurred in the past.

In the computer context, a client device may perform a variety of actions over a period of time. The performance of one or more of these actions may result in the client device being in one or more states that are undesirable and/or insecure. It is often beneficial to evaluate actions performed on or by a client device and to determine whether the actions performed on or by the client device have resulted in the client device being in one or more undesirable or insecure states.

Such undesirable or insecure states may be the result of an attack on a user or his computing device. One such threat is “phishing”, which often involves luring users to malicious websites. These malicious websites may be set up to imitate a legitimate website, for example a financial institution or e-commerce website. The user, assuming that he/she is connected to a legitimate website, may be tricked into logging in with the user's legitimate username and password. The phishing site may then steal the user's personal information. Phishing continues to be a significant problem, as perpetrators devise ever more alluring email and use sophisticated confidence schemes, all directed to stealing user's personal information.

Another threat is the more general problem of malicious software (i.e., malware). Malware is software designed to infiltrate or damage a computer system without the owner's informed consent. Some examples of malware are viruses, worms, Trojan horses, and other malicious and unwanted software. As a specific example, infected computers, often referred to as zombie computers, are used to send spam email to other computers. Other examples are spyware and adware—programs designed to monitor a user's web browsing, display unsolicited advertisements, or redirect marketing revenues to the malware creator. Such programs are generally installed by exploiting security holes or are packaged with user-installed software.

While older viruses and other forms of malware usually confined their misbehavior to self-propagation and relatively innocent pranks, today's emerging generation of malware supports infrastructure-wide attacks. Some malware assimilates infected machines into “bot” networks that propagate spam, perform click-fraud, and mount denial-of-service and other attacks. Other malware steals passwords for use in financial fraud, or even launches hidden sessions and performs covert financial transactions after a user has authenticated to a financial institution.

Some malware can execute without being shut down or deleted by the administrator of the computer on which it is executing. A Trojan horse is disguised as something innocuous or desirable in order to tempt a user to install the software without knowing what the software actually does. A Trojan horse is a program that invites the user to execute the software, but conceals a harmful or malicious program or result (i.e., payload). The payload may take effect immediately and can lead to many undesirable effects, such as deleting all of the user's files, or may install further harmful software into the user's system to serve the creator's long-term goals. Once malware is installed on a system, it is often useful to the creator if the program stays concealed.

Other malware can install itself on a client device after a client device visits a malicious website by exploiting one or more security flaws in the client device's web browser. This type of installation is often referred to as a “drive-by” installation because the malware installation does not require any user intervention. Users typically do not learn that a drive-by installation has taken place until they notice the side effects of the malware. Users may alternatively never learn about the malware residing on their computer.

Current defenses to malware rely on identifying known malware instances and patterns, using either a signature-based approach or behavioral profiling techniques. A signature-based approach compares software that has been created specifically to match the code of an already identified threat. In a static world, a signature-based malware approach can provide an excellent defense against attacks, combining a zero false negative rate with a low false positive rate—and at a low computational cost. Anti-virus software often employs signature-based approaches to combat malware.

Behavioral profiling, on the other hand, characterizes software based on what the software does. For example, behavior profiling may identify software as malware when the software performs an operation or a set of operations that are typically performed by known malware. Behavioral profiling often uses heuristics to make this comparison. Behavioral profiling offers some security against constantly changing malware instances.

Both approaches, however, ultimately suffer from the fact that they typically allow an attacker to test whether a given malware instance would be detected or not—before deciding whether to release the malware instance. Well-engineered malware, therefore, gets the upper hand against hosts attacked in a first wave—until updates to anti-virus software are distributed and deployed. To make matters worse, the time between distribution and deployment can be quite significant—sometimes on the order of weeks—due to requirements to carefully test all updates to avoid interference with other (e.g., critical) software applications. The inherent delay between initial malware release and the deployment of countermeasures constitutes a significant problem, whether consumer clients or enterprise clients are considered.

While the proactive techniques described above are beneficial in some respects, malware infection and phishing schemes will continue to be a problem as perpetrators devise increasingly complex ways of stealing personal information and infecting computers with malware. This fraudulent behavior is a problem not only for individual users, but for service providers providing various services to these users via the Internet. For example, a financial institution is at risk of loss due to fraud if one of its users has been the victim of fraud, either through a phishing scheme or through malware infection.

People have attempted to identify the transition of states of a client device using the concept of forward security, which is determining the actions performed on a client device after the actions have been performed. Forward security appears to have originated in the context of key-exchange protocols. In such systems, the aim is often to prevent compromise of a session key in the face of future compromise of the private key of a communicating party.

Bellare and Yee (M. Bellare and B. Yee, Forward integrity for secure audit logs, 1997, Technical Report, University of California at San Diego, Department of Computer Science and Engineering; Forward security in private-key cryptography, In CT-RSA, pages 1-18. Springer-Verlag, 2003. Lecture Notes in Computer Science no. 2612) first introduced the notions of forward-secure message authentication and a forward-secure log. In their scheme, the basic unit of time is an epoch. At the beginning of an epoch, the logging service sets a sequence counter to 0. Each time an entry is added to the log, the service advances the counter. When a triggering event occurs, such as a significant system event, the logging service terminates the current epoch. It writes an end-of-epoch symbol to the log, applies a message authentication code (MAC) to it, and advances to the next epoch. To ensure against modification of entries in terminated epochs, the logging service associates a different message-authentication key kᵢ to a new epoch, where it is infeasible to derive an earlier key kᵢ from a later key kᵢ₊₁.

In its basic form, this approach is subject to two forms of rollback attack by a corrupted logging service. The logging service can modify entries in the current, unterminated epoch. Additionally, the service can, on transmitting the log to a verifier, truncate it to exclude recent epochs. To prevent this latter attack, Bellare and Yee propose that the server send a nonce (a parameter that varies with time), and that the client advance to the next epoch and record the nonce as the single event for that epoch. This requires a client-server interaction at the time of log transmission, and also requires integrity protection on the nonce in the case where the server and receiver are not identical entities.

Another example of a prior art technique to audit events performed on a client device is disclosed in U.S. Pat. No. 5,978,475 to Schneier et al. (Schneier). Schneier discloses a client system registering a log file with a server. Prior to transmitting the file, the client must ensure its integrity by closing the file, logging an end-of-file entry, and deleting the log keys. To create a new log, the client has to engage in a log initialization process with the server. A drawback to this technique is the intensive client-server interaction in the case of frequent log transmission. Additionally, without the added complexity of concurrent, open logs, the system leaves open a period of time between log closure and log registration in which a client is vulnerable to compromise.

Schneier also describes a variant scheme in which a log may be verified prior to closure. That scheme, however, is subject to a rollback attack, as it does not include a provision for verification of freshness. This technique also involves a complex interleaving of operations without formal modeling or proofs.

Jin, Myles, and Lotspiech (H. Jin, G. Myles and J. Lotspiech, Towards better software tamper resistance, Information Security Conference, Springer, 2005, Lecture Notes in Computer Science, Vol. 3650; Key evolution-based tamper resistance: A subgroup extension, Association for Computing Machinery (ACM) Symposium on Information, Computer and Communications Security (ASIACCS), 2007) (hereinafter “Jin”) propose application of a forward-secure log to the problem of software tamper resistance. In the Jin system, a program records internal integrity-check events to a forward-secure log. That log is event-based—it involves no explicit closing process. This application does not aim to protect against global system compromise but rather against deviation from a correct path of software execution. As such, their challenge is to record checkable local execution events, rather than system-level events. In other words, their system attests to the integrity of the state of execution of a piece of software, proving that this state lies (or does not lie) within a predetermined state-space.

The Jin system also suffers from some technical drawbacks. To prove the freshness of its log(i.e., how current the log is), a client in their system may transmit the current key kᵢ to the server. Hence, the server must be fully trusted, i.e., identical with its verifier. Otherwise, it can replay logs and forge future log entries. In one of the proposed schemes, the logging service advances the current key before recording the current event. This can be viewed as a design flaw in that it allows a malicious logging service to tamper with the most recent log entry. In their main scheme, the current log entry serves as input in the creation of the new key. The transmitted log includes only log entries and the final key. This approach addresses the vulnerability of the first scheme to tampering. It requires the server, however, to traverse the complete log in order to verify the correctness of any entry. A lack of formalism results in some imprecision in the specification of cryptographic primitives. Jin proposes use of a “one-way function,” when a stronger property than one-wayness is needed to ensure the integrity of their system.

Therefore, there remains a need to more efficiently and securely audit actions performed on or by a client device and evaluate the actions performed on or by the client device.

### BRIEF SUMMARY OF THE INVENTION

The present invention provides a reactive network security technique for evaluating actions performed on a client device.

In accordance with an embodiment of the present invention, a client device operates to enable a server to evaluate actions performed on the client device. For each of the performed actions, the client device generates a current key from a previous key and also generates an associated action attestation value from the previous key and information about each action (stored in a log file on the client device). The client device then deletes the previous key.

Each time an audit record is to be submitted by a client device to an associated server, a final attestation value is generated using a publicly non-invertible function and based at least on the current key. The client device transmits the log file (i.e., information about the performed actions), the plurality of action attestation values, and the final attestation value to the server so that the server can authenticate the action attestation values and the final attestation value. If portions of the log file have already been audited by the server, the client device only needs to transmit yet un-audited portions.

The server evaluates the action attestation values by comparing each action attestation value to a server action attestation value that the server can compute from the action description and a key that corresponds to the authentication key used by the client device to compute the corresponding action attestation value. The server evaluates the final attestation value by comparing it to a server final attestation value. If any of the comparisons fail (e.g., the values are not substantially equivalent), then the server cannot authenticate these attestation values. The server may then determine that the log file has been tampered with or that the client device has performed a noteworthy event or action. If any of the events that are logged correspond to a known noteworthy (e.g., bad) event, then the server may take appropriate action. If any of the recorded events later is determined to be a noteworthy (e.g., bad) event, then the server may take appropriate action after this fact has been established.

In one embodiment, the server and client device initially share a secret key. In another embodiment, the server initially obtains a public key (e.g., from a public key server or from the client).

The current key becomes the previous key when a new current key is generated, and before a new action is performed on or by the client device. In one embodiment, the final attestation value is based on the current key and information involving zero or more of the following: a last action, the number of recorded actions, a nonce, a time and date that the final attestation value is computed, and information that identifies the client.

The events or actions that are considered noteworthy may be undesirable and/or insecure and may be present in a list stored by the server. Examples of actions performed on or by the client device can include downloading malware, disabling an antivirus software program, downloading copyrighted or undesirable material, originating or transmitting an email or another file, changing a configuration, and/or visiting a particular website.

The evaluation of these actions may result in determining whether a client device is likely infected by malware, has been the target of fraud, or has been used for an undesired purpose. This is different from the known techniques (e.g., virus scanners and anti-spam tools) that are directed to proactively preventing malware infection. In accordance with an embodiment of the present invention, a server can detect, after the fact, whether a user trying to connect to the server has been the victim of fraud or has had his/her computer infected with malware. This cannot be achieved by current approaches, since there, the malware may change the state and operation of its host device to suppress the correct reporting of information, thereby hiding its existence.

These and other advantages of the invention will be apparent to those of ordinary skill in the art by reference to the following detailed description and the accompanying drawings.

### BRIEF DESCRIPTION OF THE DRAWINGS

FIG. 1 is a block diagram of a system having a server in communication with a client device in accordance with an embodiment of the present invention;

FIG. 2 is a flowchart illustrating the steps performed by the client device in accordance with an embodiment of the present invention;

FIG. 3 is a flowchart illustrating the steps performed by the server to evaluate actions performed on or by the client device in accordance with an embodiment of the present invention;

FIG. 4 is a block diagram of the steps performed by the client device in accordance with an embodiment of the present invention;

FIG. 5 is a block diagram of the steps performed by the server in accordance with an embodiment of the present invention; and

FIG. 6 is a high level block diagram of a computer implementation of a network component in accordance with an embodiment of the present invention.

### DETAILED DESCRIPTION

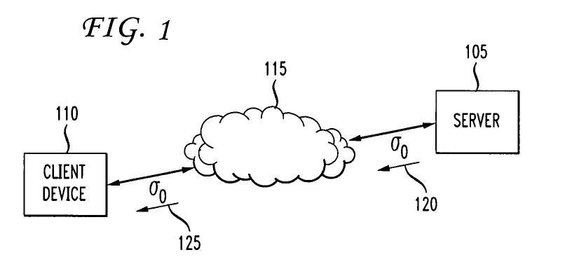

FIG. 1 shows a system 100 having a server (also referred to below as S) 105 in communication with a client device (also referred to below as M) 110 over a network 115 such as the Internet. In accordance with an embodiment of the present invention, the server 105 evaluates actions performed on the client device 110. This evaluation may result in a particular determination such as that malware has infected the client device 110, that the client device 110 has downloaded copyrighted material, that the client 110 has originated or transmitted an email or another file, that the client device 110 has disabled antivirus software previously executing on the client device 110, or any other determination. In one embodiment, the server 105 maintains a list of actions that are noteworthy and to be detected. Once the server 105 detects that a particular action has been performed on the client device 110, the server 105 may take some action such as stop communicating with the client device 110, begin communicating with another device, call a telephone number associated with the client device 110 to alert the owner of the client device 110, email the client device 110, sound an alarm, etc.

Examples of an action that is performed on or by the client device 110 include the accessing of a website, the installation of a new program, disabling antivirus software, downloading copyrighted material, processing a file using some already installed program, originating or transmitting an email or another file, executing code or receiving or displaying an email by an email client.

The client device 110 can be any computing device, such as a handheld device, desktop computer, laptop computer, telephone, etc. The server 105 may be any computing device such as a server associated with a network service provider or an anti-virus company, firewall, router, access point, ignition key (circuitry in a key associated with a vehicle), vehicular black box, smart card, handheld device, laptop computer, desktop computer, telephone, etc.

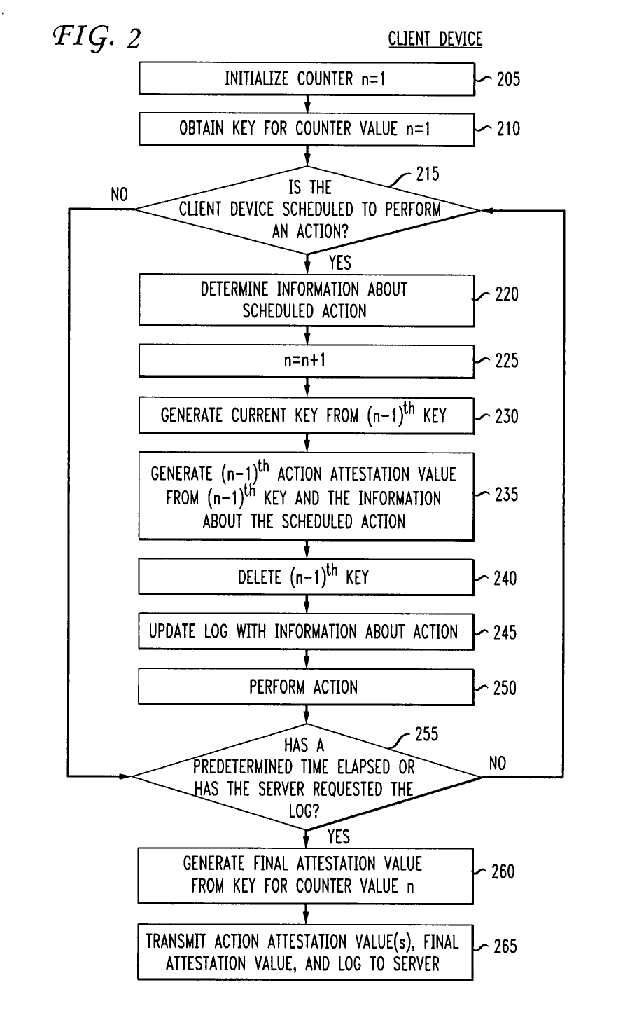

FIG. 2 shows a flowchart illustrating an embodiment of the steps performed by the client device 110 in accordance with an embodiment of the present invention. The client device 110 initializes a counter n to 1 in step 205. The client device 110 may also store its initial state in a log file. The client's initial state may include information about the programs the client device 110 has installed previously, the files the client device 110 stores, etc.

The client device 110 computes, determines, or obtains a key for counter value n=1 in step 210. In one embodiment, and as shown in FIG. 1, the client device 110 receives a secret key Γ₀ that is transmitted from the server 105 (as shown with arrows 120 and 125). In one embodiment, the server 105 selects the value of the secret key at random for each client device with which the server 105 communicates. Each selected secret key is unique and independent from other secret keys. Thus, after the client device 110 receives the secret key Γ₀ only the server 105 and the client device 110 know the value of the secret key Γ₀. The user of the client device 110 never needs to know the value, nor does the administrator of the server 105. In one embodiment, both the server 105 and the client device 110 store the secret key Γ₀.

In another embodiment, the 1^{st} key is a public key. As a result, the client device 110 may obtain the 1^{st} st key from, for example, a public key server (which may be different than or the same as the server 105). The client device 110 may also obtain the associated secret key from the server 105 or another server.

In yet another embodiment, the first key is also a public key. This, along with the associated secret key, may be computed by the client device 110. The client device 110 would then report the public key to a public key server (which may be different from the server 105).

The client device 110 then determines, in step 215, whether the client device 110 is scheduled to perform an action. If so, then the client device 110 determines information about the scheduled action in step 220. In one embodiment, the information is a description of the action that is going to be performed, such as downloading a program, visiting a URL, or disabling antivirus software executing on the client device 110. The description would then include information about what program is downloaded, what URL is visited, or what other action is performed. This description may be based on the name of the operation or program, or describe the computational operations taken as a result of the event. For example, the description of the action scheduled to be performed can be the URL that is about to be visited by the client device 110 or text describing the program that is going to be downloaded (e.g., the program's name, size, author, date of creation, etc.).

The client device 110 may record an action or event (e.g., store details about the action or event in a log) in its completeness. For example, the recording of an event may be storing information about a complete program being installed, along with a description of the circumstances of its installation. The client device 110 may also record shorter descriptions of events. For example, instead of recording the complete apparent functionality of a webpage that is being visited, the client device 110 may record the URL of the webpage alone. In some contexts, it may also be relevant to record all the interaction associated with a given event. For example, and going back to the webpage example, one may record the URL in one record, and then all the interaction that the user and the client device 110 performs with the webpage. This may include execution of scripts, input of data, and other forms of interaction. It may, further, sometimes be of interest to store anonymized pieces of information. As an example, if a user visits a webpage on a given blacklist, the client device 110 may record the mere fact that this happened, along with the version of the blacklist, instead of recording the URL of the webpage. This results in a privacy benefit. It also sometimes may be meaningful to record segments of code instead of entire programs or scripts, or patterns of resource uses of a program that is run in a sandbox. It may also be useful to treat the client device 110 as middleware and trap all requests of certain types, and treat certain types of requests, or combinations thereof, as events. The client device 110 may then record a description of such requests, potentially along with the context of the call. The content may be what program made the call, who or what process initiated the execution of the program, etc.

The client device 110 then increments n by one (i.e., n=n+1) in step 225 and generates a current key for counter value n (e.g., a 2^{nd} key) from the (n−1)^{th} (e.g., 1^{st}) key in step 230. The client device 110 then generates an (n−1)^{th} action attestation value (in this case, the 1^{st} action attestation value) from the (n−1)^{th} (e.g., 1^{st}) key and the information about the scheduled (first) action in step 235. Once the (n−1)^{th} (e.g., 1^{st}) action attestation value is generated, the (n−1)^{th} (e.g., 1^{st}) key is deleted in step 240. The client device 110 then updates a log with the previously determined information (determined in step 220) about the (1^{st}) action in step 245 and then performs the action in step 250. The client device 110 then determines whether a predetermined time has elapsed or whether the server 105 has requested information (e.g., the log or the attestation value(s)) from the client device 110.

If not, the client device 110 returns to step 215 to determine whether another action is scheduled to be performed. If an action is scheduled, the client device 110 repeats steps 220 to 255 again.

If no action is scheduled, the client device 110 returns to step 255. In step 255, the client device 110 determines whether a predetermined time has elapsed or whether the server has requested the log. If so, the client device 110 generates a final attestation value from the key for counter value n in step 260. As described in more detail below, the final attestation value prevents the client device 110 from transmitting a log with information about some of the actions performed on or by the client device 110, but not including descriptions of the most recent actions. Thus, the final attestation value prevents a corrupted or misconfigured client device 110 from transmitting only the corresponding action attestation values associated with actions it wishes to be seen by the server 105. The final attestation value instead requires the client device 110 to transmit a log having information about all of the actions performed on or by the client device 110 before receiving the request from the server (or before a predetermined time has elapsed) as well as their corresponding action attestation values. The client device 110 then transmits the action attestation value(s), final attestation value, and log to the server 105 in step 265. Here, the client device 110 would not have to transmit portions of the log that have already been audited by the server 105. In one embodiment, the final attestation value is erased by the client device 110 after having been transmitted.

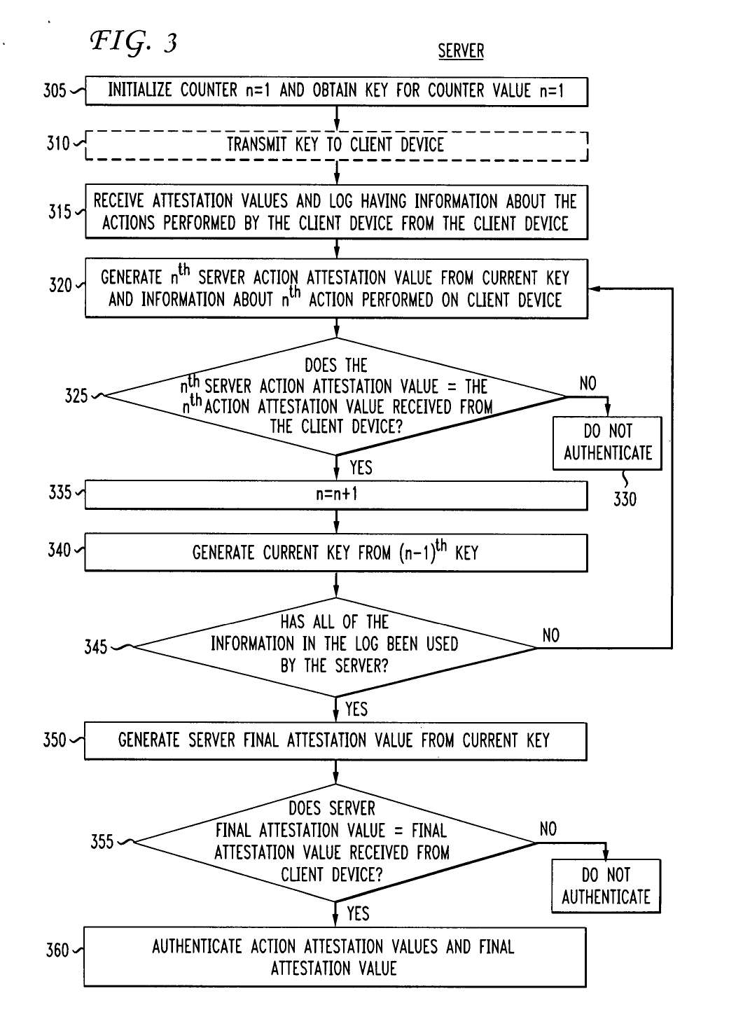

FIG. 3 shows a flowchart illustrating the steps performed by the server 105 when auditing the client device 110 in accordance with an embodiment of the present invention. In step 305, the server 105 initializes its own counter n to 1 and obtains the key for counter value n=1. The server 105 may generate the 1^{st} key (e.g., a secret key), may obtain the first key from another computer on the network 115 (e.g., a public key obtained from, a public key server or the client device 110), etc. In one embodiment, the server 105 transmits the (1^{st}) key to the client device 110 in step 310 (shown with dashed lines). If portions of the log have already been audited, then the server 105 may initialize its own counter n to a number that corresponds to the first element of the log that has not yet been audited.

The server 105 then receives the attestation values (the action attestation value(s) and the final attestation value) and the log file from the client device 110 in step 315. The server 105 then generates an n^{th} server action attestation value from the current (at this stage in the processing, the 1^{St}) key and from the information about the n^{th} (at this stage in the processing, the 1^{st}) action performed on the client device 110 in step 320. In step 325, the server 105 compares the n^{th} server action attestation value with the n^{th} action attestation value received from the client device 110. If they are not the substantially equivalent (e.g., the same), then the server 105 does not authenticate the n^{th} action attestation value received from the client device 110 in step 330. In one embodiment, the server 105 alerts the user of the client device 110 that a noteworthy action has been performed on the client device 110 and additional steps may need to be taken. For example, the server 105 may send an email to the client device 110 indicating that the previously transmitted action attestation values did not authenticate and so the client device 110 may be infected with malware. Similarly, if the final attestation value does not authenticate, e.g., the received value is different from the value the server 105 computes, then the server 105 may conclude that the client logs have been tampered with. Moreover, if the final attestation value is not fresh, e.g., has already been verified, relates to an old nonce or a long-passed date and time, etc., then the server 105 may conclude that the client logs have been tampered with, or that a third party is attempting to interfere with the audit. In such a case, the server 105 may ignore the received values and avoid counting the audit session as valid. It may then require another audit session to be performed with the client device 110.

If the n^{th} server action attestation value equals the n^{th} action attestation value received from the client device 110, the server 105 then increments n by 1 in step 335. The server 105 then generates a new key (the current key for counter value n) from the previous (n−1)^{th} key in step 340. The server 105 then determines if all of the information in the log has been used by the server 105 (to generate all of the server action attestation values) in step 345. If not, the server 105 repeats steps 320 through 345 for a (new) n^{th} server action attestation value generated from the (new) current key and from the information about the n^{th} action performed on the client device 110.

If the server 105 determines in step 345 that all of the information in the log has been used by the server 105, the server 105 generates a server final attestation value from the current key in step 350. In step 355, the server 105 then compares the server final attestation value with the final attestation value received from the client device 110 to determine whether the values are equal. If the final attestation values are not equal, the server 105 does not authenticate the final attestation value received from the client device 110. This may indicate that, for example, one or more actions performed on the client device 110 may have tampered with the log file (e.g., malware altered the log file by deleting the action in the log file associated with the loading of the malware in order to prevent detection of the malware on the client device 110).

If the final attestation values are substantially equivalent (e.g., the same) in step 355, and they are considered fresh, then the server 105 authenticates the action attestation values and the final attestation value received from the client device 110 (step 360). This authentication may indicate that the actions performed on the client device 110 have likely not resulted in harm to the client device 110. For example, the client device 110 likely still has its antivirus software running, does not have malware executing on the client device 110, etc.

It should be noted that, unlike the client device 110, the server 105 does not delete the previous (i.e., (n−1)^{th}) key. This enables the server 105 to generate all of the keys that the client device generated and, as a result, to determine each (server) action attestation value as well as its final attestation value. It should also be noted that the server 105 can request and receive the information from the client device 110 at a particular time and may, at some later point in time, determine that the client device 110 is infected with malware or has performed some particular action.

The list of action events to be recorded may be selected at the time the client device 110 is initialized, or when the audit software or hardware is installed. The list of action events to be recorded may also be modified at any other time, whether by reconfiguration requested by as user of the client device 110, or by request from the server device 105. Such a reconfiguration would preferably constitute an event to be recorded. The choice of the type of action or events to be recorded is a matter of anticipated threat, system resources, and likely and common types of operations. A person skilled in the art will see that it is possible to record navigation to URLs, any GET request, any execution, the execution of selected types of software or modules, use of selected communication interfaces, changes to the machine configuration, etc., or any combination of these.

The auditing technique performed by the server 105 may detect direct or indirect evidence of dangerous network activity. Direct evidence can be, for example, evidence that the client computer 110 has initiated network connections to known phishing sites or to sites known to distribute malware. Indirect evidence can be, for example, that the client device 110 has initiated network connections to websites to which infected computers are often directed. For example, certain malware, when installed on a client device 110, direct that client device 110 (perhaps unknown to the user) to websites. Connection to those websites by a client device 110 can be indirect evidence that the computer is infected by malware.

Another form of indirect evidence of infection of a given strain of malware is evidence of another form of malware infection. In particular, it is possible that there is a first type of malware with a notable harmful payload, and a second type of malware with a potentially less harmful payload. The first type of malware may be much harder to detect than the second type of malware, or may not be as wide-spread. It is possible, however, that these two pieces of malware rely on exactly the same type of vulnerability for their spread. Thus, indications of the presence of the second type of malware suggest the presence of the common type of vulnerability, which in turn increases the likelihood that the same machine is also infected with the first type of malware. Thus, detection of the second type of malware is a meaningful indication of a higher risk to be affected by the first type of malware, whether it is actually present or not. Thus, the server 105 can detect detectable risks and also increased likelihoods of detectable risks.

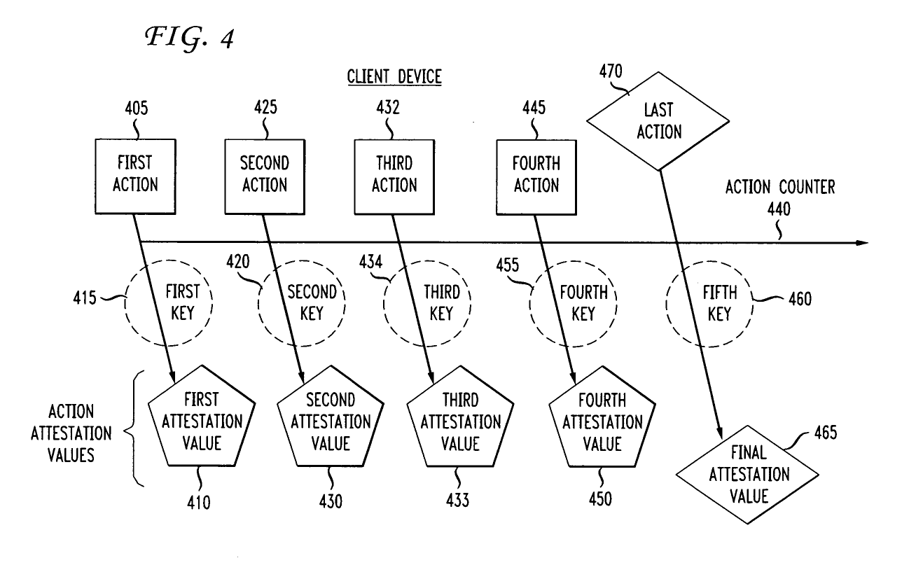

FIG. 4 shows a block diagram of the process performed by the client device 110 in accordance with an embodiment of the present invention. The client device 110 obtains a first key 415. As described above, the first key 415 may be the secret key Γ₀ or may be a public key.

Before a first action 405 is performed by the client device 110, the client device 110 generates a second key 420 from the first key 415. The client device 110 then generates a first action attestation value 410 from information about the first action 405 and from the first key 415.

As used herein, the “current” key is the key that has been most recently generated. The current key therefore changes over time. As used herein, the “previous” key is the key that was generated immediately before the current key. The previous key therefore also changes over time. As a result, the current key at one stage in the processing of the algorithm becomes the previous key during the next stage in the processing of the algorithm. Thus, as described above, after the second key is generated, the second key is considered the current key (for a period of time) and the first key is considered the previous key (for a period of time). When a third key is generated, then the third key is considered the current key (for a period of time) and the second key is considered the previous key (for a period of time). Before the second key is generated, the first key can be considered to be the current key and there is no previous key.

After the first action attestation value 410 is generated, the client device 110 deletes the first (at this stage in the processing, the previous) key 415. This deletion is shown in FIG. 4 with a dashed line. After the first (previous) key 415 is deleted, the first (previous) key 415 cannot be determined again from any of the remaining information. The first action 405 is then performed on or by the client device 110. Erasure of keys and other data can be performed in a multitude of ways, and may involve iterated rewriting of affected memory cells with other data, as understood by a person skilled in the art.

When a second action 425 is scheduled to be performed (which is next along an action counter 440), the client device 110 generates a third (at this stage in the processing, the current) key 434 from the second (at this stage in the processing, the previous) key 420. The client device 110 then produces a second action attestation value 430 from information about the second action 425 and from the second (previous) key 420. The client device 110 then deletes the second (previous) key 420. After the second (previous) key 420 is deleted, the second (previous) key 420 cannot be determined again from any of the remaining information. The second action 425 is then performed on or by the client device 110.

When a third action 432 is scheduled to be performed, the client device 110 generates a fourth (at this stage in the processing, the current) key 434 from the third (at this stage in the processing, the previous) key 420. The client device 110 uses the third key 434 and information about the third action 432 to generate a third action attestation value 433. Once the third action attestation value 433 is generated, the client device 110 deletes the third (previous) key 434 (as shown with dashed lines). After the third (previous) key 434 is deleted, the third (previous) key 434 cannot be determined again from any of the remaining information.

When a fourth action 445 is scheduled to be performed, the client device 110 generates a fifth (at this stage in the processing, the current) key 460 from the fourth (at this stage in the processing, the previous) key 455. The client device 110 uses the fourth (previous) key 455 and information about the scheduled fourth action 445 to generate a fourth action attestation value 450. Once the fourth action attestation value 450 is generated, the client device 110 deletes the fourth (previous) key 415, as shown with the dashed lines. After the fourth key 455 is deleted, the fourth key 455 cannot be determined again from any of the remaining information.

Thus, in one embodiment the client device 110 has generated four action attestation values 410, 430, 433, and 450, has information about four actions 405, 425, 432, and 445 (stored in a log), and is storing a current fifth key 460 which was previously generated from a fourth key 455 (which has been deleted). If the server 105 requests the log from the client device 110 (or, in another embodiment, if a predetermined time has elapsed), the client device 110 generates a final attestation value 465 from at least the fifth key 460. In one embodiment, the generation of the final attestation value 465 is logged as a last action 470. The final attestation value 465 is generated using a publicly non-invertible function. A publicly non-invertible function is a function that cannot be inverted by a party not in possession of a secret key used to invert the key, or other auxiliary knowledge not known to the public. Examples of publicly non-invertible functions include but are not limited to: application of a one-way function, such as a hash function, application of a public-key operation, such as squaring modulo certain large composite integers, or truncation of the key to a drastically reduced portion of the key. It is well understood that some publicly non-invertible functions may not be invertible by any party at all, whereas others are invertible by parties with knowledge of some specific information.

As described above, the final attestation value 465 is used to prevent tampering with the log file. For example, if malware is downloaded onto the client device 110, the malware may want to hide the fact that it is executing on the client device 110. The malware may do this by causing the client device 110 to transmit only actions 405, 425, and 432 and their corresponding action attestation values 410, 430, 433 (and not the fourth action 445 and its corresponding action attestation value 450) to the server 105. Without the final attestation value 465, the server 105 may be able to authenticate the first, second, and third action attestation values 410, 430, 433, but cannot complete the authentication, as a final attestation value will be missing.

In accordance with an embodiment of the present invention, the server 105, however, receives the final attestation value 465. As the final attestation value 465 is based on the fifth (at this stage in the processing, current) key 460 and because the malware cannot go backwards in time to obtain the deleted fourth key 455 (to generate a different fifth key), the server 105 can determine that the log file has been tampered with because the final attestation value 465 will not match the number of keys produced (five). Alternatively, the server 105 may not receive the final attestation value 465, in which case the absence of such a value would indicate that the log may have been tampered with. A malware infected machine cannot go backwards in time to obtain a previous key from which it can generate a final attestation value on an action that is not the most recently recorded action.

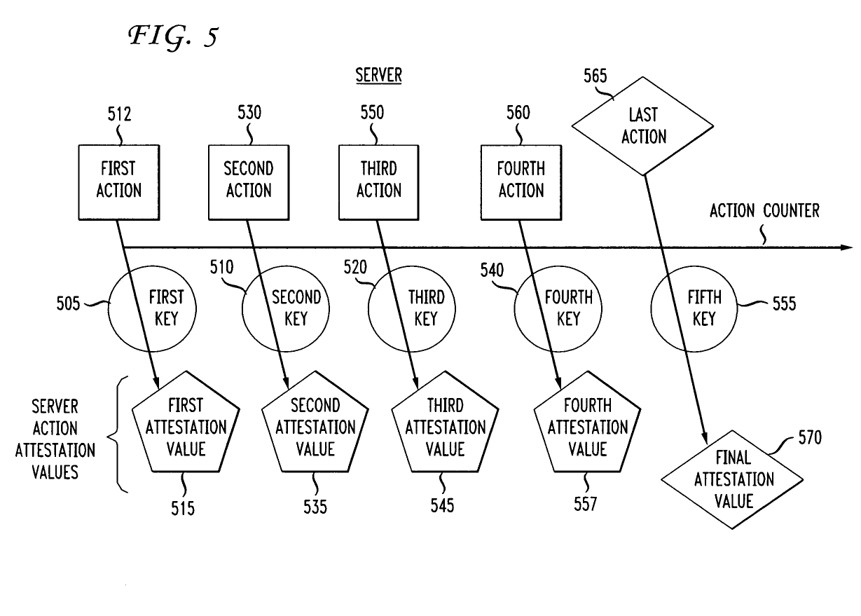

FIG. 5 is a block diagram of the process associated with the audit of the client device 110 by the server 105 in accordance with an embodiment of the present invention. The server 105 obtains the first key 505. As described above, the server 105 may generate the first key 505 or may obtain the first key 505 from a public key server. In contrast to the client device 110, the server 105 does not have to erase previous (i.e., old) keys. Instead, the server 105 may maintain all keys, computing each of the keys as needed.

In particular, during an audit, the server 105 obtains the client log and the action attestation values 410, 430, 433, 450, 465 from the client device 110. The server 105 generates a second (at this stage in the processing, the current) key 510 from the first key 505. As described above with respect to FIG. 3, the server 105 uses the first (at this stage in the processing, the previous) key 505 and information about the first action 512 (from the received log) to generate a first server action attestation value 515. The server 105 can then compare its first server action attestation value 515 with the received first action attestation value 410 and determine if they match. If they do match, then the server 105 can generate a third (current) key 520 from the second (previous) key 510 and use the previous second key 510 and information about a second action 530 (received from the client log) to generate a second server action attestation value 535. The server 105 can then compare its second server action attestation value 535 with the previously received second action attestation value 430 to authenticate the second action attestation value 430.

If there is a match, the server 105 can then generate a fourth (current) key 540 from the (previous) third key 520. The server 105 can then determine a third server action attestation value 545 from the third key 520 and information about the third action 550 received from the client device 110. The server 105 can then compare the third server action attestation value 545 with the third action attestation value 433 received from the client device 110.

If there is a match, the server 105 can then generate a fifth (current) key 555 from the (previous) fourth key 540. The server 105 can then determine a fourth server action attestation value 557 from the fourth key 540 and information about the fourth action 560 received from the client device 110. The server 105 can then compare the fourth server action attestation value 557 with the fourth action attestation value 450 received from the client device 110.

As described above, if there is a match, the server 105 then determines that it is up to a last action 565. The server determines, from the fifth (current) key 555, a server final attestation value 570 and compares this server final attestation value 570 to the final attestation value 465 received from the client device 110. If they match, the attestation values have been authenticated. If they do not match, such as if the server 105 only receives information about a first, second, and third action 512, 530, 550 and not the fourth action 560, then the server 105 does not authenticate one or more of the attestation values.

In one embodiment, embodiments of the invention can be applied to vehicular computing. Car computers can interact with other computational devices, such as telephones, in order to synchronize actions, update a state, or carry out a transaction. Car computers may interact with other types of computers, e.g., other vehicles, of service stations, and of toll booths. When doing this, one of the devices may potentially be infected by the other. This risk is higher when one or more of the connecting devices are also in frequent contact with, or within transmission range of, other devices that may be infected by malware.

As an example, consider an attack in which a victim is deceived or convinced to install software that is harmful to him, or an attack in which similar software is automatically installed on the machine of the victim by means of a technical vulnerability, such as buffer overflow. If a third party were to keep a log of all installations or other qualifying actions made on the victim machine, then the former action can be detected from these logs. Similarly, if a third party were to keep a log of all critical actions that allow for installation due to technical vulnerabilities, then the latter action could be detected from such logs. As described above, critical actions may include browser actions involving visits to new sites, execution of javascript code, the receipt or display of an email by an email client, and more.

In accordance with an embodiment of the present invention, a first device is configured to record at least one action/event in a forward-secure log (i.e., to store a description of at least one action/event in a file (log) in order to later be verified after the at least one action/event has occurred). The first device computes a final attestation value for at least a portion of the log. A second device verifies the integrity of the at least a portion of the forward-secure log from the final attestation value.

The at least one action/event may be, for example, a software-configuration event, creation of a communication session with another device, execution of software, downloading software, installing software, and a change in system security policy. A description of the action/event may be recorded in the log prior to the execution of the action/event (e.g., prior to the downloading of the software). Further, the first device may retrieve software-classification data and a software configuration record having a classification of the software. The software classification data may be a list of software distribution points. The software configuration record may be one or more of a URL from which software is downloaded by the first device, an IP address from which the software is downloaded by the first device, values derived from at least some of the software, and a web site certificate.

In one embodiment, the second device can select an access-control procedure to control access to the first device based on whether the integrity of the log has been verified. The access-control procedure may include execution of a device-authentication procedure and a user-authentication procedure.

The following is a more mathematical description of the algorithms described in FIGS. 2 and 3 above, and describe a public-key variant of the method. A forward-secure signature scheme is a digital signature algorithm (G, S, V) for which S and V are a function of a counter t that could represent time or other events/actions. G is a function that takes a random string as input and generates a secret key sk and public key pk, both associated with t=t_{—}0 for some initial counter value t_{—}0. The signing algorithm S takes t and a function of sk as input, along with a message m, and produces an output s. The verification algorithm V takes t and a function of pk as input, along with m and s, and outputs a binary value representing whether s is a valid signature on m for the interval t and the public key that is a function of pk.

Consider a particular type of forward-secure signature scheme where there is at least one portion of state associated with t such that this state for a time interval t_k can be computed from this state for a time interval t_j if and only if k≧j. This state is referred to as z_t, where t indicates the time interval. There are many possible implementations of such a portion of a state. For example, one could store a list of values (z_{—}0, z_{—}1, z_{—}2 . . . z_n) where z_{t+1}=f(z_t) for some one-way function f and where z_n is part of, associated with, or a partial preimage of the initial value of pk. At time interval t, only (z_t, z_{t+1}, . . . z_n) is stored, and the remaining items of the list are securely erased. The value z_t can be verified to be correct by application of f the correct number of times (which should result in z_n) and the verification that this value corresponds correctly to the initial value of pk. It would not be possible to “step back” the state by computing a value z_{t−1} from a list of values (z_t, . . . z_n), even with the help of other information to be stored by the machine in question. This kind of forward secure signature scheme may be referred to as being “self-timed”—it carries with its state information about the minimum time t of the system.

Consider a timed forward-secure signature scheme. A first node (e.g., the server 105) can generate initial values of sk and pk and (z_{—}0, . . . z_n) and transmit this information to a second node (which may be the same as the first node) (e.g., the client device 110). The second node (e.g., the client device 110) generates a signature on each observed critical event before this event is allowed to take place. As part of the signature generation, the state z_t is updated. The message that is signed corresponds to a description of the critical event to be carried out.

Given the above description, it can be seen that software that gains control as a result of a critical event cannot tamper with the state in a manner that will not be detected. Notably, erasing the log of events will be detectable by a third party, as will the removal of any event that is already known by a third party wishing to verify the logs. Moreover, it is not possible to replace the logs or to remove the last part of the logs, as it will be infeasible to compute an already erased value z_t. The described invention allows this type of abuse to be detected.

Therefore, this structure allows for third-party verification of the logs kept by a given node. If any log is found to have been tampered with, then the verifier will conclude that the corresponding machine (e.g., the client device 110) is infected. Refusal to submit logs upon request will be interpreted in the same way, as will failure to connect at requested time intervals. Therefore, it is not possible for malware to hide its tracks by erasing its installation logs. This will allow post-mortem analysis of potentially infected machines by a third party, such as a provider of anti-virus software. In one embodiment, the verifier is the server 105.

An embodiment of the invention uses symmetric key primitives, combined with a pseudo-random generator whose state cannot be rewound, and a counter whose state cannot be rewound.

In particular, we can let s0 be an initial seed, and s_i=f(s_{i−1}) for a one-way function f that could be chosen as a hash function such as SHA-1 or may be a pseudorandom function generator. The value s_i is the state of the pseudo-random generator at the time of the ith event. Note that one can compute the state of a later event from the state of an earlier event, but not the other way around. This is due to the fact that the one-way function f cannot be inverted.

Second, let MAC_k be a one-way function that is keyed using the key k, and which produces a y=MAC_k(x) given an input x and a key x. Here, MAC is chosen to be a one-way function, and can be based (as is well understood by a person skilled in the art) on a hash function, such as SHA-1. Alternatively, MAC can be chosen as a digital signature function, such as RSA.

Let m_i be a message that corresponds to a description of the ith event, where i is a counter that starts at 1 for the first event, and which is incremented by one after each event is recorded. Let s_i be the current state kept by the machine to be protected. All previous values of the state are assumed to be erased. A machine acting as a verifier has stored at least the initial state s_{—}0 of the machine to be protected, and potentially other state values as well. Let t_i be a time indicator corresponding to the time right after event i has been recorded.

Before the event corresponding to m_i is allowed to take place, the machine to be protected performs the following steps:
1. Erase t_{i−1}.
2. Compute y_i=MAC_{s_i}(m_i) and store y_i. This is referred to as the authenticated event descriptor.
3. Compute t_i=MAC_{s_i}(y_i,i) and store t_i. This is referred to as the time indicator.
4. Compute s_{i+1}=f(s_i, aux_i) and store s_{i+1}. Here, aux_i is an optional input, which can be a random or pseudo-random value. Also, f may ignore part of its input, and thus s_{i+1} may strictly be a function of aux_i.
5. Compute an optional key verification value, which is part of the attestation value, and which is a function of both s_i and s_{i+1}, where the function may be MAC {s_i}(Encr {s_i}(s_{i+1}), where MAC is a message authentication function or a digital signature and Encr is an encryption function, and where the quantity s_i is interpreted as the key. In a public-key version of the scheme, the MACed quantity can be the new associated public key.
6. Erase s_i.
7. Increment i by 1 and store the new value of i.

To verify whether the protected machine has been compromised, the verifying machine requests a copy of (i,y_{i1} . . . y_{i2}, m_{i2} . . . m_{i2},t_{i2}), where i1 is a counter indicating the first value of i for which the events are to be verified, and i2 a counter indicating the last event to be verified. This is set to i−1. The value of i1 could be any value greater than or equal to 0 and less than i. The machine to be protected sends the requested values to the verifying machine. In one embodiment, the connection is secure, using encryption or a secure physical transmission channel, allowing only the intended verifying machine to decrypt the received data. In one embodiment, the connection is also assumed to be authenticated.

The verifying machine performs the following steps:
1. Set i=i1, and compute s_i from the already stored state values. Set alert=0.
2. Compute z_i=MAC_{s_i}(m_i) and compare to y_i. If not, then set alert=1.
3. Verify if m_i is a secure event. If not, then set alert=1.
4. Increment i. If it is less than i2, then go to step 2.
5. Compute r_{i−1}=MAC_{s_{i−1}}(y_{i−1},i−1) and compare to t_i2. If not equal, then set alert=1.
6. If any of the values expected to be received are of the wrong format or not present, then set alert=1.
7. If alert=0 then the machine to be protected is considered safe, otherwise not.

Here, the event description m_i could be a function g of the code to be installed during event i, to be executed during event i. It could also be a function of a URL to be visited, or any other description of a user-driven machine event, or any other description of a machine-driven event. The function g may be a compressing function, or a function that truncates input, or which extracts a portion of the input, another function of the input, or any combination of these. The functions described are assumed to be known by both the machine to be protected and the verifying machine.

The time indicator can be computed in other ways than described. It needs to be a one-way function of a state value s_j (where j may be a positive constant value smaller than i, where the constant value 0 has been used). It is also possible to let the time indicator be a value from which previous time indicator values cannot be computed, but from which one can compute future time indicator values. This avoids a “rewinding of time” if old time indicator values are erased after the corresponding event has occurred.

The sequence of keys may be generated using a pseudo-random function generator that takes as input a seed value and a counter that is specific to each key.

The sequence of keys may be generated using a random or pseudo-random function, where there is no particular relation between the keys, but where each action comprises the generation of a new key, and the key is included in the associated attestation value. The keys can either be communicated using a key exchange protocol or key delivery protocol, or be known by both server and client beforehand.

It is possible to let the functionality of the protected machine depend on the successful verification of security of the same machine by a protected machine. This can be done by the protected machine encrypting portion of its state and erasing the decryption key, where the decryption key is known by the verifying machine and will be sent to the protected machine after the verification stage has been passed. Similarly, vital portions of the state of the protected machine can be erased by the protected machine, and can be kept by the verifying machine, which would send over these vital portions after the verification succeeds.

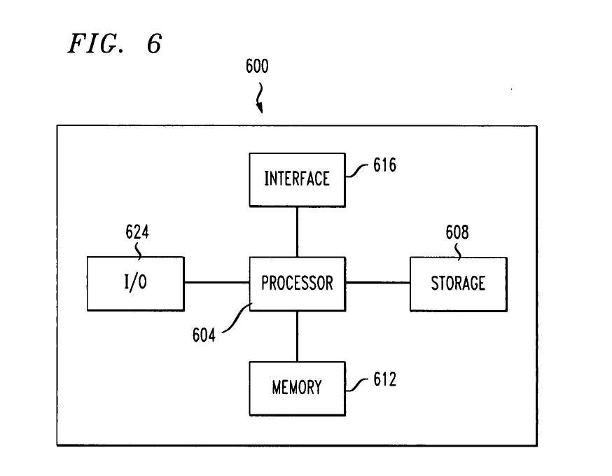

The previous description describes the present invention in terms of the processing steps required to implement an embodiment of the invention. These steps may be performed by an appropriately programmed computer, the configuration of which is well known in the art. An appropriate computer may be implemented, for example, using well known computer processors, memory units, storage devices, computer software, and other nodes. A high level block diagram of such a computer is shown in FIG. 6. Computer 600 contains a processor 604 which controls the overall operation of computer 600 by executing computer program instructions which define such operation. The computer program instructions may be stored in a storage device 608 (e.g., magnetic disk) and loaded into memory 612 when execution of the computer program instructions is desired. Computer 600 also includes one or more interfaces 616 for communicating with other devices (e.g., locally or via a network). Computer 600 also includes input/output 624 which represents devices which allow for user interaction with the computer 600 (e.g., display, keyboard, mouse, speakers, buttons, etc.). Computer 600 may represent the server 105 and/or the client device 110.

One skilled in the art will recognize that an implementation of an actual computer will contain other nodes as well, and that FIG. 6 is a high level representation of some of the nodes of such a computer for illustrative purposes. In addition, one skilled in the art will recognize that the processing steps described herein may also be implemented using dedicated hardware, the circuitry of which is configured specifically for implementing such processing steps. Alternatively, the processing steps may be implemented using various combinations of hardware and software. Also, the processing steps may take place in a computer or may be part of a larger machine.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method of operation of a client device for enabling a server to evaluate a plurality of actions performed on the client device, said method comprising:
for each of said plurality of actions,
(a) generating a current key,
(b) generating an associated action attestation value based on a previous key and information about said each action, and
(c) deleting said previous key;
generating a final attestation value based at least on said current key using a publicly non-invertible function; and
transmitting information about said plurality of actions, a plurality of action attestation values, and said final attestation value to said server so that said server can authenticate said plurality of action attestation values and said final attestation value.

2. The method of claim 1 wherein the action comprises at least the generation of said current key.

3. The method of claim 1 further comprising receiving a first key from said server.

4. The method of claim 1 wherein said current key becomes said previous key when a new current key is generated before another action is performed by said client device.

5. The method of claim 1 wherein said previous key is a key generated immediately before said current key.

6. The method of claim 1 wherein said final attestation value is based on said current key and information about a last action.

7. The method of claim 1 wherein said each of said plurality of actions further comprises at least one of downloading malware, disabling an antivirus software program, downloading copyrighted material, originating or transmitting an email or another file, changing a configuration, and visiting a particular website.

8. A method for determining that a log of events transmitted by a first device to a second device has been tampered with, the method comprising:
receiving a plurality of action attestation values, a final attestation value, and said log from said first device;
evaluating said plurality of action attestation values and said final attestation value; and
determining that said log has been tampered with based on said evaluating step.

9. The method of claim 8 wherein the tampering is a result of malware infection of said first device.

10. The method of claim 8 wherein the tampering is a result of an adverse user-initiated event.

11. The method of claim 8 further comprising, for each event in said log of events, generating a current key based on a previous key.

12. The method of claim 11 further comprising, for each event in said log of events, generating an associated server action attestation value based on said previous key and information about said each event in said log.

13. The method of claim 12 wherein said evaluating further comprises comparing said associated server action attestation value with a corresponding action attestation value in said plurality of action attestation values.

14. The method of claim 11 further comprising generating a server final attestation value based at least on said current key.

15. The method of claim 14 wherein said evaluating further comprises comparing said server final attestation value with said final attestation value.

16. The method of claim 8 further comprising using a publicly non-invertible function to generate said final attestation value.

17. A computer readable medium comprising computer program instructions capable of being executed in a processor and defining the steps comprising:
for each of a plurality of actions performed on a client device,
(a) generating a current key,
(b) generating an associated action attestation value based on a previous key and information about said each action, and
(c) deleting said previous key;
generating a final attestation value based at least on said current key using a publicly non-invertible function; and
transmitting information about said plurality of actions, a plurality of action attestation values, and said final attestation value to a server so that said server can authenticate said plurality of action attestation values and said final attestation value.

18. The computer readable medium of claim 17 further comprising computer program instructions defining the step of receiving a first key from said server.

19. The computer readable medium of claim 17 wherein said current key becomes said previous key when a new current key is generated before another action is performed by said client device.

20. The computer readable medium of claim 17 wherein said previous key is a key generated immediately before said current key.

21. The computer readable medium of claim 17 wherein said final attestation value is based on said current key and information about a last action.

22. The computer readable medium of claim 17 wherein said each of said plurality of actions further comprises at least one of downloading malware, disabling an antivirus software program, downloading copyrighted material, originating or transmitting an email or another file, changing a configuration, and visiting a particular website.

23. A server for determining that a log of events transmitted by a device to said server has been tampered with, the server comprising:
means for receiving a plurality of action attestation values, a final attestation value, and said log from said device;
means for evaluating said plurality of action attestation values and said final attestation value; and
means for determining that said log has been tampered with from said means for evaluating.

24. The server of claim 23 further comprising means for generating a current key from a previous key for each event in said log of events.

25. The server of claim 24 further comprising means for generating a server action attestation value based on said previous key and information about said each event for each event in said log of events.

26. The server of claim 25 wherein said means for evaluating further comprises means for comparing said server action attestation value with a corresponding action attestation value.

27. The server of claim 24 further comprising means for generating a server final attestation value based at least on said current key.

28. The server of claim 27 wherein said means for evaluating further comprises means for comparing said server final attestation value with said final attestation value.

29. The server of claim 23 further comprising means for generating said final attestation value using a publicly non-invertible function.

30. A computer readable medium comprising computer program instructions capable of being executed in a processor and defining the steps comprising:
receiving a plurality of action attestation values, a final attestation value, and a log of events from a first device;
evaluating said plurality of action attestation values and said final attestation value; and
determining that said log has been tampered with based on said evaluating step.

31. The computer readable medium of claim 30 further comprising, for each event in said log of events, computer program instructions defining the step of generating a current key based on a previous key.

32. The computer readable medium of claim 31 further comprising, for each event in said log of events, computer program instructions defining the step of generating an associated server action attestation value based on said previous key and information about said each event in said log.

33. The computer readable medium of claim 32 wherein said evaluating step further comprises computer program instructions defining the step of comparing said associated server action attestation value with a corresponding action attestation value in said plurality of action attestation values.

34. The computer readable medium of claim 31 further comprising computer program instructions defining the step of generating a server final attestation value based at least on said current key.

35. The computer readable medium of claim 34 wherein said evaluating step further comprises computer program instructions defining the step of comparing said server final attestation value with said final attestation value.

36. The computer readable medium of claim 30 further comprising computer program instructions defining the step of using a publicly non-invertible function to generate said final attestation value.

37. A system comprising:
a first device configured to record at least one event in a forward-secure log and configured to compute a final attestation value for at least a portion of said forward-secure log; and
a second device configured to verify the integrity of said at least a portion of said forward-secure log from said final attestation value.

38. The system of claim 37 wherein said at least one event is at least one of a software-configuration event, creation of a communication session with another device, execution of software, and installing software.

39. The system of claim 38 wherein said at least one event is downloading software by said first device.

40. The system of claim 39 wherein said at least one event is recorded before said downloading of said software.

41. The system of claim 38 wherein said at least one event is recorded before at least one of a software-configuration event, creation of a communication session with another device, execution of software, and installing software.

42. The system of claim 39 wherein said first device is further configured to retrieve software-classification data and a software configuration record comprising a classification of said software.

43. The system of claim 42 wherein said software-classification data is a list of software distribution points.

44. The system of claim 42 wherein said software configuration record comprises at least one of a URL from which said software is downloaded by said first device, an IP address from which said software is downloaded by said first device, values derived from at least a portion of said software, and a web site certificate.

45. The system of claim 37 wherein said at least one event is a change in system security policy.

46. The system of claim 37 wherein said second device is further configured to select an access-control procedure for said first device.

47. The system of claim 46 wherein said access-control procedure further comprises execution of at least one device-authentication procedure and user-authentication procedure.

48. A method comprising:
recording, by a first device, at least one event in a forward-secure log;
computing, by said first device, a final attestation value for at least a portion of said forward-secure log; and
verifying, by a second device, the integrity of said at least a portion of said forward-secure log from said final attestation value.

49. The method of claim 48 wherein said at least one event is at least one of a software-configuration event, creation of a communication session with another device, execution of software, and installing software.

50. The method of claim 48 wherein said at least one event is downloading software by said first device.

51. The method of claim 50 wherein said recording of said at least one event occurs before said downloading of said software.

52. The method of claim 38 wherein said recording of said at least one event occurs before at least one of a software-configuration event, creation of a communication session with another device, execution of software, and installing software.
